(19) United States
(12) Patent Application Publication
(10) Pub. No.: US 2013/0215037 A1
(43) Pub. Date: Aug. 22, 2013

(54) MULTI-TOUCH SURFACE KEYBOARD WITH MULTI-KEY ZONES ON AN ADAPTABLE HOME LINE AND METHOD OF INPUTTING TO SAME

(71) Applicant: Dun Dun Mao, Burnaby (CA)

(72) Inventor: Dun Dun Mao, Burnaby (CA)

(21) Appl. No.: 13/766,616

(22) Filed: Feb. 13, 2013

Related U.S. Application Data
(60) Provisional application No. 61/600,937, filed on Feb. 20, 2012.

(51) Int. Cl. G06F 3/041

(52) U.S. Cl. CPC G06F 3/041
USPC 345/168

(57) ABSTRACT

A multi-touch surface such as of a touch screen on a platform of an electronic device has a distribution of touch sensitive keys each corresponding to a letter, number, symbol or function. The keys are grouped into pads, each pad being operable by a different one of a user's ten fingertips. The locations of the pads may conform to the shape and size of a user's hands, and to their position and orientation in relation to the screen, and is such that the screen can comfortably be used for typing. Sub-pads may be arranged in proximity to the pads for access by the corresponding finger. A modified version of the key pattern can be used for smaller touch screens.

### TECHNICAL FIELD

This subject matter relates to data entry interfaces for electronic devices. More particularly, it relates to a multi-touch surface configured as an application-independent keyboard for comfortable and efficient use with two hands.

### BACKGROUND

In modern mobile digital devices such as tablets, notebooks and cell phones, space is at a premium and use of a touch screen is almost universal. Electronic devices with multi-touch screens are often configured with well known QWERTY, AZERTY, DVORAK or other traditional keyboard layouts for accepting user inputs of text, numbers, characters and commands. The use of a multi-touch screen for text entry is often not as convenient as using a conventional keyboard because multi-touch screens usually present a smaller area than conventional keyboards, making for a somewhat cramped layout of the keys and a more pronounced and uncomfortable wrist angle.

U.S. Pat. No. 7,057,607 discloses a user interface for a touch screen in which user inputs are categorized as either a swish type stroke or a non-swish type stroke. If the stroke is a non-swish, it is translated into an application function. If the stroke is a swish, it is converted in to a character.

U.S. Pat. No. 6,104,317 discloses a data entry device with input regions for receiving stroke inputs, where input regions have multiple characters indicated on them. Strokes are correlated with characters.

### SUMMARY OF INVENTION

The present invention is directed to any electronic device with a multi-touch surface that may be configured as a two-handed keyboard interface. It is also directed to a method in which the positions of the individual finger pads and sub-pads, representing screen character input areas, are arranged to lie on a typically curved home line that automatically adapts to the size, shape and orientation of the user's hands. Characters can be entered on the multi-touch surface by finger taps, short directional strokes to or from the home line, or combinations thereof. The invention is also directed to an equivalent keyboard for a small screen such as on a smart phone.

Accordingly, one aspect of the present invention disclosed is an electronic device with an adaptable keyboard, comprising a platform having a multi-touch surface configured with a keyboard; a memory on the platform storing computer readable instructions; and a processor on the platform connected to the memory and the multi-touch surface; said computer readable instructions configured, upon processing by said processor, to cause the device to: define a pad at each of a plurality of locations on the multi-touch surface, wherein: each location corresponds to a different fingertip of a user; each of the pads comprises three touch sensitive keys; and each of the touch sensitive keys is assigned to a character; detect activation of a selected one of the touch sensitive keys; and register in the memory the character corresponding to the selected one of the touch sensitive keys activated; wherein the keys of each of the pads include a central one of the keys located on a home line aligned with rest positions of the fingertips.

Further disclosed is a method for operating an electronic device as an adaptable keyboard, comprising: defining, by a processor in the device, a pad at each of a plurality of locations on a multi-touch surface of the device, wherein: each location corresponds to a different fingertip of a user; each of the pads comprises three touch sensitive keys; and each of the touch sensitive keys is assigned to a character; detecting, by the processor, activation of a selected one of the touch sensitive keys; and registering, by the processor, in a memory of the device, the character corresponding to the selected one of the touch sensitive keys activated; wherein the keys of each of the pads include a central one of the keys located on a home line aligned with rest positions of the fingertips.

Still further disclosed is an electronic device with a keyboard, comprising: a platform having a multi-touch screen configured with a keyboard; a memory on the platform storing computer readable instructions; and a processor on the platform connected to the memory and the screen; said computer readable instructions configured, upon processing by said processor, to cause the device to: define a pad at each of a plurality of locations on the screen, wherein: each of the pads comprises three touch sensitive keys; and each of the touch sensitive keys is assigned to a character; display a home line on the screen, wherein the keys of each of the pads include a central one of the keys located on the home line; detect activation of a selected one of the touch sensitive keys; register in the memory the character corresponding to the selected one of the touch sensitive keys activated; and display the home line on the screen temporarily deformed towards a non-central one of said keys not located on the home line when said non-central key is activated.

### BRIEF DESCRIPTION OF DRAWINGS

The drawings illustrate embodiments of the invention, which should not be construed as restricting the scope of the invention in any way.

FIG. 1 is a schematic side cutaway view of an electronic device with an exemplary embodiment of a multi-touch surface in accordance with the present invention.

FIG. 2 is a user's view of an exemplary embodiment of a keyboard layout on the multi-touch surface of the electronic device of FIG. 1.

FIG. 3 is a diagram of a home line, in relation to a user's hands.

FIG. 4 is a user's view of another exemplary embodiment of a keyboard, including sub-pads.

FIG. 5 shows a flowchart for calibrating the keyboard.

FIG. 6 is a flowchart for determining the mode of operation of the keyboard.

FIG. 7 is a flowchart for personalizing the character assignments of the keyboard.

FIG. 8 is an equivalent layout of the letters of the keyboard for a smart phone.

FIG. 9 is an alternate keyboard layout.

### DETAILED DESCRIPTION

Throughout the following detailed description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

The description is also presented in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that software implemented processes may be embodied in hardware, firmware, or software, in the form of coded instructions such as in microcode and/or in stored programming instructions.

Definitions of some terms used in this disclosure:

Multi-touch surface—Relating to computing and electronic devices, this is a touch sensitive surface that can detect the presence of one, two or more points of contact on its surface, such as a user's fingertips. Points of contact could also be finger nails, gloved fingers or styli depending on the technology of the multi-touch screen. There is not necessarily a display on such a surface or provided behind or through such a surface, but characters and/or keys may be printed on or embedded in such a surface.

Multi-touch screen—A multi-touch screen refers to a display with a multi-touch surface. A multi-touch screen has the ability to recognize the presence of one, two or more points of contact on its surface. In most cases these points will be a user's fingers but could also be finger nails, gloved fingers or styli depending on the technology of the multi-touch screen. There are several types of multi-touch screen technology appropriate for use with the invention, including, for example, capacitive, infra-red, optical imaging and dispersive signal.

Multi-touch plate—A multi-touch surface without a display.

Fingers—When used herein, this term may include a user's thumb as well as the user's other digits. Likewise, a fingertip may be taken to mean a tip of a thumb as well as a tip of a finger.

Character—A letter, number, symbol, punctuation mark or function (such as ‘Enter’, ‘Delete’, etc). A character is registered by a processor in an electronic device after a user has applied one or more tapping or sweeping actions to the multi-touch surface on or connected to the electronic device.

Key—A key is a portion of the multi-touch surface to be tapped in order for a user to cause the processor of the electronic device to register a character. Each key is assigned a default character, but the user can modify any default character or assign an alternative keypad or keyboard layouts. A key may also be registered by a user sweeping a fingertip either over it, towards it, from it, or within a pad or sub-pad containing the key.

Pad, Key Pad, Finger Pad or Main Key Pad—Generally refers to an area or zone of the multi-touch screen or multi-touch surface allocated with a particular set of keys and intended to be used by a single finger. A pad may be identified by the finger with which it is intended to be used, e.g., thumb pad. A pad is typically located under the rest position of a fingertip and on the home line.

Home Line—A typically wavy line that connects, and is therefore aligned with, the rest positions of the user's fingertips when the user's fingers are resting on the multi-touch surface. The home line may still considered to be aligned with the user's fingertips if their rest position is slightly above the multi-touch surface. On larger touch surfaces, there is enough room for the home line to be wavy, according to the actual rest position of the fingertips. For equivalent keyboards on smaller touch screens, such as found in smart phones, the home line may be straight, and may either be fixed or correspond, for example, to the rest positions of a user's thumbs while holding the device.

Subsidiary Pad, Sub-Pad or Sub Key Pad—An area, zone or sub-zone of the multi-touch screen or multi-touch surface that is located close or adjacent to a main key pad, but not under the rest position of a fingertip. A sub-pad is allocated with a particular set of keys and intended to be used by a single finger. A sub-pad may be identified by the finger with which it is intended to be used, e.g. middle finger sub-pad.

Simultaneous tapping—Refers to tapping two or more fingers together on the multi-touch screen. In practice, the fingers will not actually be tapped simultaneously, and so simultaneous tapping is meant to cover cases where the fingers are tapped sufficiently close in time to each other that they can be interpreted as being tapped together. A time difference between two such taps would be significantly less than the time difference between the same two fingers being intentionally tapped individually for the purpose of registering two separate characters.

Up, Above—When describing a location on a multi-touch surface as up or above, it should be understood that this may mean generally or predominantly upwards in relation to a lower edge of the surface. This includes up and slightly to the left, but not so much as to be confused with what would be a predominantly left direction. Similarly, it includes up and slightly to the right, but not so much as to be confused with what would be a predominantly right direction. In some contexts, up may mean above the home line.

Down, Below—When describing a location on a multi-touch surface as down or below, it should be understood that this may mean generally or predominantly downwards towards a lower edge of the surface. This includes down and slightly to the left, but not so much as to be confused with what would be a predominantly left direction. Similarly, it includes down and slightly to the right, but not so much as to be confused with what would be a predominantly right direction. In some contexts, down may mean below the home line.

Left, Right—When describing a location on a multi-touch surface, these directions may mean predominantly to the left or the right respectively, and may include a component of up or down that is not sufficient to cause confusion with a predominantly up or down direction.

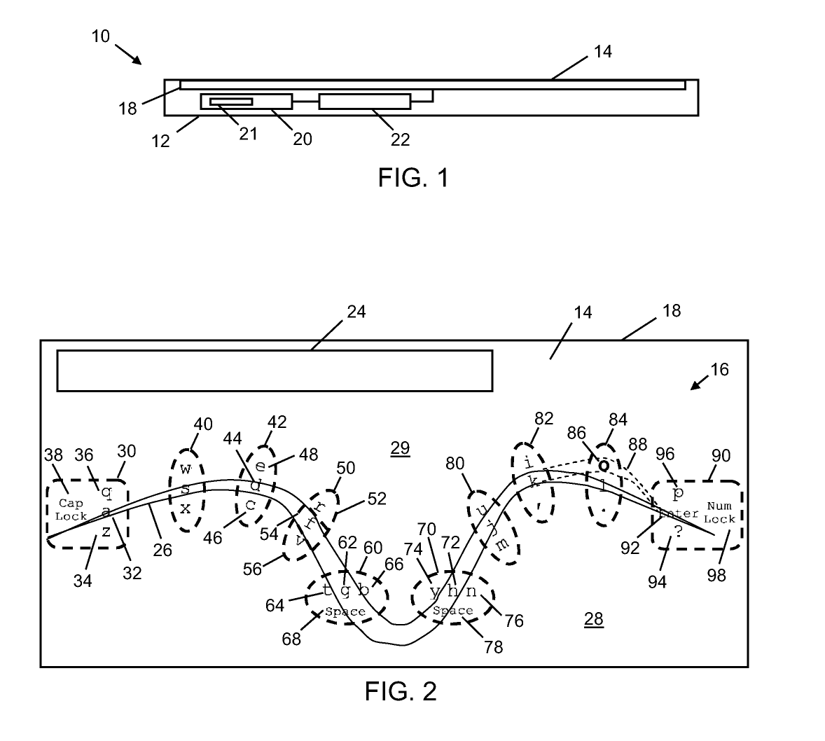

Referring to FIG. 1, an exemplary embodiment of an electronic device 10 is shown that includes a platform 12 having a multi-touch surface 14 thereon configured with a single-hand keyboard 16, as seen in FIG. 2. The platform 12 may also include a multi-touch screen 18 having the multi-touch surface 14. The electronic device 10 also includes a memory 20 and one or more processors 22 connected to the memory 20 and to the multi-touch surface 14. Computer readable instructions 21 are stored in the memory 20 and processed by the processor(s) 22 in order to control the multi-touch surface 14 and if necessary the output of the multi-touch screen 18. The processor(s) 22, by reading the computer readable instructions 21, are also responsible for interpreting any finger touch inputs received at the keyboard 16 of the multi-touch surface 14 of the multi-touch screen 18. The memory 20 may in part or in whole be located within the processor(s) 22. Examples of electronic devices 10 that can be configured for the adaptable home line on a multi-touch screen keyboard 16 include the iPad™ tablet and other similar tablet computing devices. Peripheral multi-touch screens 18 that plug into desktops and laptops may also be included. Program coding for the adaptable home line keyboard 16 may be achieved using known programming languages.

Referring to FIG. 2, an example of the home line keyboard 16 is shown. Letters of the alphabet are displayed on the screen 18 to help users locate the keys, although this is not necessary. The screen 18 optionally includes an area for character display 24 showing input by the user. At separate locations on the multi-touch surface 14, the keyboard 16 displayed by the multi-touch screen 18 includes multiple key pads, preferably five key pads 30, 40, 42, 50, 60 for the left hand and five key pads 70, 80, 82, 84, 90 for the right hand. For the left hand there is a little finger pad 30, ring finger pad 40, middle finger pad 42, index finger pad 50, and thumb pad 60. For the right hand there is a thumb pad 70, index finger pad 80, middle finger pad 82, ring finger pad 84, and little finger pad 90.

Each key pad (30, 40, 42, 50, 60, 70, 80, 82, 84, 90) is aligned over the home line 26. In some cases, the center of a key pad (e.g. key pads 40, 42) is aligned over the home line 26, but this is not necessarily true for all, such as for key pads 30, 90.

Each finger's assigned key pad (30, 40, 42, 50, 60, 70, 80, 82, 84, 90) of the keyboard 16 includes multiple keys. Each of the key pads includes a respective single, central key (e.g. central keys 32, 44, 62, 72, 92) and respective multiple, non-central keys (e.g. non-central keys 34, 36, 38, 46, 48, 64, 66, 68, 74, 76, 78, 86, 94, 96, 98). Each non-central key in a pad may be activated by a tap or a swipe, resulting in the registration by the processor of a character.

The central characters (a, s, d, f, g, h, j, k, l, Enter) assigned to the central keys of each corresponding key pad (30, 40, 42, 50, 60, 70, 80, 82, 84, 90) are aligned over the home line 26.

Referring to the left hand little finger pad 30, it includes four keys (32, 34, 36, 38), where the central key 32 is activated when the left hand little finger taps the multi-touch surface 14 in its rest position. Lower key 34 is activated when the left hand little finger taps on the pad 30 a little way from its rest position, on the lower side 28 of the home line 26. Upper key 36 is activated when the left hand little finger taps on the pad 30 at a location a little way from its rest position, on the upper side 29 of the home line 27. Left key 38 is activated when the left hand little finger taps on the pad 30 a little way to the left of its rest position.

Referring to the left hand middle finger pad 42, it includes three keys (44, 46, 48), where the central key 44 is activated when the left hand middle finger taps in its rest position. Lower key 46 is activated when the left hand middle finger taps on pad 42 a little way from its rest position on the lower side 28 of the home line 26. Upper key 48 is activated when the left hand middle finger taps on pad 42 at a location a little way from its rest position, on the upper side 29 of the home line 26. Left hand ring finger pad 40, left hand index finger pad 50, right hand index finger pad 80, right hand middle finger pad 82 and right hand ring finger pad 84 function in a similar way to pad 42.

Referring to the left thumb pad 60, it includes four keys (62, 64, 66, 68), where the central key 62 is activated when the left thumb taps in its rest position. Left key 64 is activated when the left thumb taps on pad 60 a little way to the left of its rest position, on the lower side 28 of the home line 26. Right key 66 is activated when the thumb taps on pad 60 a little way to the right of its rest position, on the upper side 29 of the home line 26. Lower key 68 is activated when the thumb taps on pad 60 a little way below its rest position.

Referring to the right thumb pad 70, it includes four keys (72, 74, 76, 78), where the central key 72 is activated when the right thumb taps in its rest position. Left key 74 is activated when the right thumb taps on pad 70 a little way to the left of its rest position, on the upper side 29 of the home line 26. Right key 76 is activated when the thumb taps on pad 70 a little way to the right of its rest position, on the lower side 28 of the home line 26. Lower key 78 is activated when the thumb taps on pad 60 a little way below its rest position. Note that in this embodiment, the Space character has been allocated to the two keys 68, 78, and that activation of either one of the keys will result in a Space being registered.

Referring to the right hand little finger pad 90, it includes four keys (92, 94, 96, 98), where the central key 92 is activated when the right hand little finger taps the multi-touch surface 14 in its rest position. Lower key 94 is activated when the right hand little finger taps on pad 90 a little way from its rest position, on the lower side 28 of the home line 26. Upper key 96 is activated when the right hand little finger taps on pad 90 at a location a little way from its rest position, on the upper side 29 of the home line 26. Right key 98 is activated when the right hand little finger taps on pad 90 a little way to the right of its rest position.

The home line 26 may be optionally displayed on the screen 18. If it is displayed, it may optionally be made to indicate when characters are registered. For example, if a user taps on the “o” key 86, the home line may be temporarily deformed towards it, or displayed in position 88 in the region of the “o” key, or displayed as moving to, and then from, position 88. This applies to all keys situated off the home line 26. Other means of providing visual feedback may be used, such as displaying the registered character temporarily in bold 86 or a different colour. The colour or the intensity of the home line may also be changed, particularly for indicating that a character on the home line 26 has been registered.

Keys in a key pad may be contiguous or they may be separated by a gap which does not respond with the processor 22 registering a character. The shapes of the keys may be square, rectangular, rhomboid, semi-circular, regular, irregular, elliptical, semi-elliptical, curved, complex, or many other possible shapes. For example, key pad 50 is shown as divided into upper key 52, central key 54 and lower key 56.

Positions of the key pads (30, 40, 42, 50, 60, 70, 80, 82, 84, 90) of the keyboard 16 on the multi-touch screen 18 may be different to those shown, depending on the orientation, shape and size of the user's hand, and orientation and position of the multi-touch surface.

Each individual finger key pad (30, 40, 42, 50, 60, 70, 80, 82, 84, 90) extends from a central position to a perimeter of its respective location on the multi-touch surface 14 that can be reached by the corresponding fingertip without bodily displacement of the hand. For example, the pads can be covered by the fingertips without lifting the wrists if they are supported. The pads are not large enough to overlap, although in some embodiments overlap may be allowed if the keyboard 16 is configured to discern which finger is moving or causing the action. Furthermore, it is intended that while the user may need to bend or extend the fingers, or move them sideways, undue stretching of the fingers is not necessary.

Keys in a key pad may each be activated by tapping thereon. Alternately, depending on the configuration implemented, the central key in a key pad may be activated by tapping anywhere in the key pad. Non-central keys in the key pad may be activated be swiping towards them, anywhere in the pad. This may be the case for all fingers and all key pads. Non-central keys may alternately be activated by a cycle of a sweep to the key followed by a return to the rest position. A certain tolerance for inaccurate sweeps may be built into the keyboard. By limiting the number of keys in a key pad to three, for most of the key pads, makes the keyboard easier to master. It also creates the impression that, when sweeping towards non-central keys, the user is flicking or plucking the home line 26. This will be reinforced if the home line is made to temporarily move as a result of a flick. The resulting visual impression will be that the home line looks like an oscillating string.

The character display area 24 may be shaped, positioned or angled differently, according to the user's preferences or to the particular application the user is using. The optional character display area 24 may not appear on the multi-touch screen 18, such as when the home line keyboard 16 is used as a peripheral multi-touch screen connected to a desktop or other computer having a monitor that can display the entered text. This may also happen when the device 10 is embodied in a multi-touch plate that is connected as a peripheral to another computing device. Where a multi-touch plate is used, the keys will not be displayed on it, although it is possible to print on the plate or another surface of the device an indication as to which keys correspond to which characters, without necessarily locating the indications at actual positions of the keys since these are intended to change to suit each user. For example, a key chart may be printed across an upper edge of the multi-touch plate. In other embodiments, the keys may be displayed on a monitor of a computing device to which the multi-touch plate is connected.

Optionally, the keyboard displayed in FIG. 2 may be shifted to display further characters by swiping two fingers (e.g. the thumb and little finger of one hand) upwards at the same time on the screen, on their respective main pads. By swiping down, the prior or default screen will once again be displayed.

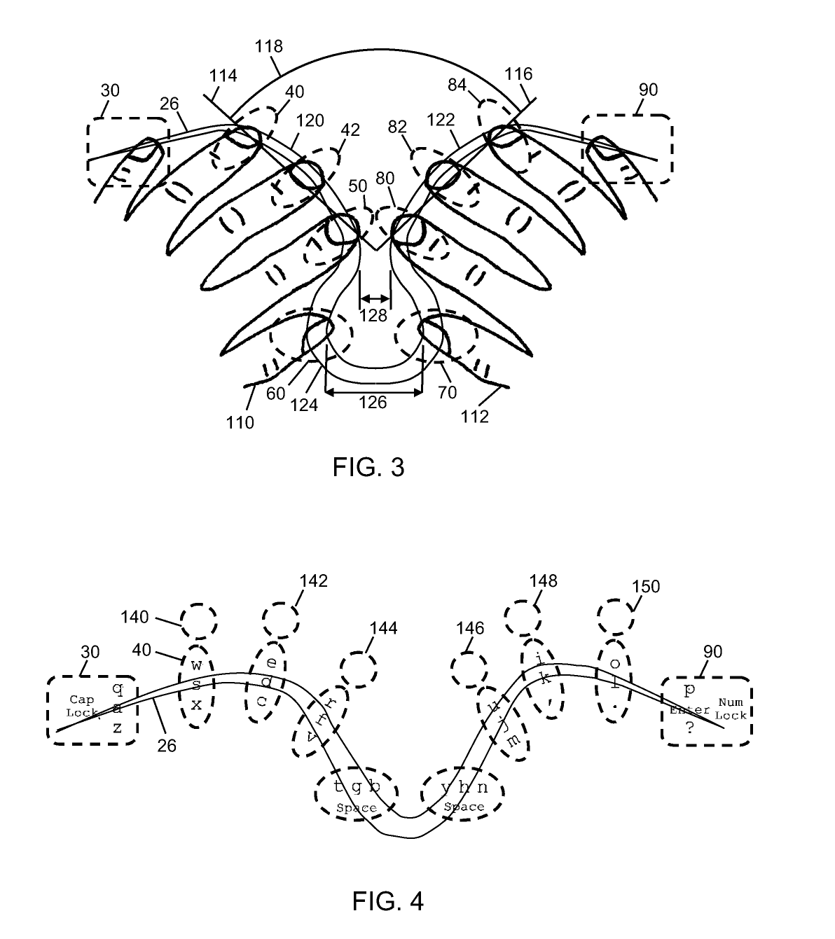

Referring to FIG. 3, the home line 26 of the adaptable home line keyboard is shown in a different shape. A user's hands 110, 112 are shown in a relaxed position over a multi-touch surface 14 of the multi-touch screen 18. The user's fingers are slightly curved and the fingertips may or may not be touching the surface 14 of the screen 18. The user's wrists may rest on a surface on which the screen 18 is supported, on wrists supports, or they may hover without support.

At separate locations on the home line 26, the ten key pads (30, 40, 42, 50, 60, 70, 80, 82, 84, 90) are shown, each at a location corresponding to the rest position of a user's respective fingertip.

Note that when the home line 26 is in this shape, it has a loop 124 in the middle with an internal sideways width 126 and neck 128. When the user's hands are positioned further away from each other, the width 126 and neck 128 of the loop 126 increase accordingly. Portions 120 and 122 of the home line 26 make an angle 118 with each other, approximately following the line 114 through the middle three fingers of the left hand 110 and the line 116 through the middle three fingers of the right hand 112. Depending on the angle between the user's forearms when using the keyboard, and the angles the user's wrists are set at, angle 118 may change. For example, the angle 118 will be more acute when the keyboard is used closer to the body than when it is used further from the body. As shown here, the angle is very roughly a right angle, but it may vary from roughly 0° to roughly 180°.

FIG. 4 shows an alternate configuration of the keyboard with subsidiary key pads 140, 142, 144, 146, 148, 150. Main key pads, such as key pad 40, are the same as those described above. The subsidiary pads 140, 142, 144, 146, 148, 150 are included proximal to, and generally above, the main key pads. The sub-pads may even be adjacent to the pads. The sub-pads are generally splayed and angled with respect to each other, in a fan-like orientation and in conformity with how a user's fingertips spread out from a relaxed hand position to a slightly and naturally stretched out and comfortable hand position. Sub-pads may be used for additional characters, such as numbers or other punctuation marks.

The keys in each of the sub-pads may be activated by tapping on them. They may also by activated by swiping the fingertip downwards, upwards, left, right or diagonally within the sub-pad. There may be one, two or more keys in a sub-pad, depending on the configuration chosen. Sub-pads do not need to have the same number of keys as each other.

Note that the little finger pads 30, 90 have been configured as main pads. They may instead each have been configured as a combination of a main pad and a sub-pad. For example, the left hand little finger main pad could include the letters Q, A, and Z, while a sub-pad to the left could include the Caps Lock key.

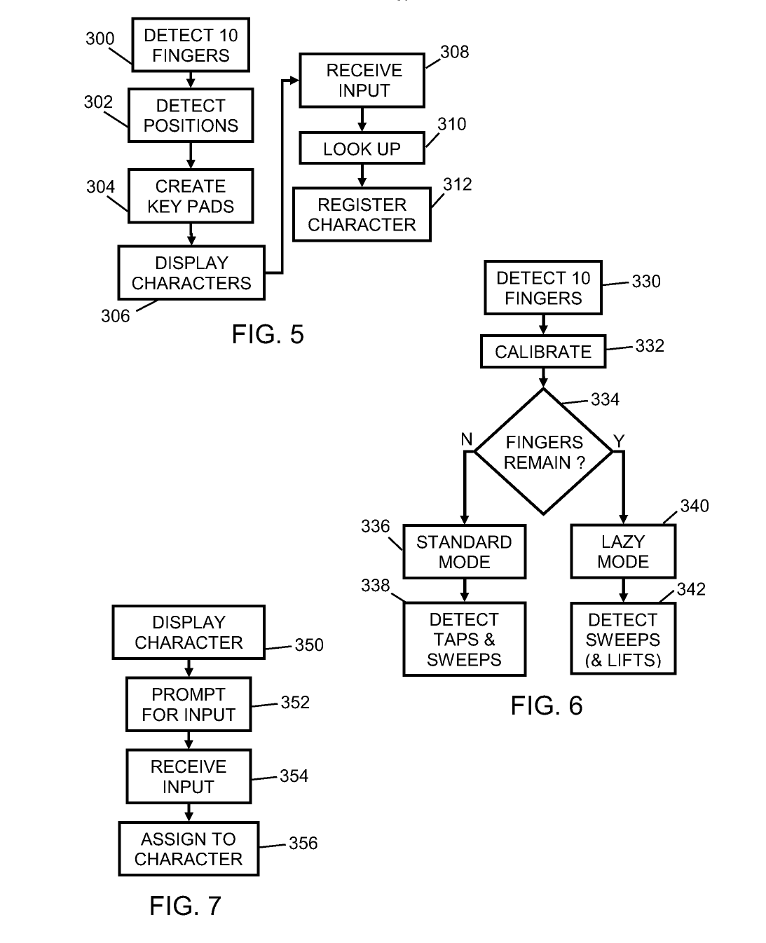

FIG. 5 shows a process which an electronic device 10 performs when configured as a home line keyboard. In step 300, the multi-touch screen detects contact with ten fingers and the processor determines the positions of contact of the ten fingers in step 302. The processor, in step 304, creates key pads each centered on one of the positions of contact previously detected. The processor then, in step 306, causes the multi-touch screen to display, at the locations of the pads, the characters for each of the keys in the ten pads. In step 308, the screen then monitors for contact and receives an input from the user, such as a tap or a sweep. The processor determines where on the screen the input occurred and in step 310 looks up in memory the character or function to which the key is assigned. The processor then registers the looked up character in step 312, which may include displaying the character in a text entry field on the touch screen.

At any point, if the adaptable home line keyboard detects the simultaneous contact of ten fingers; it may jump to step 300 to recalibrate the system. The display of the keys may therefore automatically adjust, resulting in a changed display position whenever the system re-calibrates the resting position of the fingers.

In step 308, when the screen is in ‘listening’ mode and receives an input, the processor is configured to allow for a fraction of a second wait in anticipation of other fingers possibly touching the keyboard. If other fingers came in contact with the keyboard within this fraction of a second, then the action will be registered as a combo key. The exact amount of time may be set by default, it may be learnt by monitoring an analyzing corrections made by a user, or it may be set by requesting the user to enter some test multiple-finger taps and then taking the longest period between first and last contacts. Other methods for determining the time wait may also be used. Such a combo key may be for the use of two fingers together to register less common characters.

Calibration may continue for each finger sweep during a set period of use, or on an ongoing basis. To increase directional sweep accuracy, a set number of directional sweeps may be recorded and the keyboard may be calibrated according to the median directional angles of each finger sweep. Equally, when tapping, a running average position of taps for a given key may be continually monitored, and the display location and response area of that key may be dynamically adjusted as required.

FIG. 6 shows a flowchart of a process used by the processor to determine which mode the user is operating the screen in, if it is not set by default or selected by the user. The keyboard allows the user to use two different operational modes. For example, in a standard mode, the user's hand may hover above the keyboard, the user's fingers making contact with the keyboard only when activating keys through taps or sweeps. In this mode, the rest position of the fingertips can be considered to be slightly above or apart from the multi-touch surface, the rest position being the position to which the fingertips naturally return after activation of a key. In a lazy mode, the user's fingers rest on the board and keys are registered by directional sweeps of individual or multiple fingers.

Instead of sweeps, the user may lift a finger and put it down to register the same key as a tap. This would be the case for keys located at the rest position of the finger tips and for multiple-finger taps. For registering keys that are off center, the user may sweep towards that key, then lift and return to the center key, or rest position. Alternately, the user may lift a finger from the rest position and land on an off-center key to register it, and then let the finger sweep back to the rest position.

More advanced error correction subroutines are contemplated as necessary to compensate for the more significant twitches of other fingers when registering keys in the lazy mode. This mode is more difficult to use than the standard mode because it is possible to accidentally move a finger and unintentionally register a different key. A user when proficient at operating the keyboard in the lazy mode will look like his fingers are making tiny twitches. Significantly less physical effort is required for this mode once a certain level of proficiency has been attained.

Returning to FIG. 6, in step 330 the presence of ten fingers in contact with the screen is detected. In step 332, the keyboard is calibrated as before, to determine the positions of the key pads. In step 334, the process determines whether or not the ten fingers remain in contact with the screen. If they do not remain, the keyboard operates in standard mode 336, and detects taps 338 and/or sweeps that each start and finish with the finger out of contact with the screen. If in step 334 the fingers are detected to remain in contact with the screen, the keyboard operates in lazy mode 340, and goes on to detect sweeps 342 that are preceded and/or followed by the finger resting on the screen, and lifts followed by rests in contact with the screen to register characters located on the home line.

FIG. 7 shows a process in which the home line keyboard may be customized. For example, in step 350, the keyboard may display a character, and prompt for an input that corresponds to that character in step 352. Following the receipt in step 354 of an input from the user, such as a tap, sweep, lift and replace, double tap, etc., the processor then assigns the received input to the displayed character in step 356, storing the relation in memory.

Depending on the embodiment implemented, some or all of the keys and some or all of the required actions to register them may be displayed on the home line keyboard.

Once a key is registered, the corresponding key may momentarily light up or change color. In other embodiment, an audible click may be emitted. Subtle sweeping motion trails may be transiently displayed as feedback to show the user that sweeping actions have been recognized. Visual feedback may be provided in many different forms, including a color change, a font change, a font size change, a brightness change etc. Vibrating or wavering motion of the home line may be displayed.

Smart phones may be configured with an equivalent keyboard, with the same or nearly the same arrangement of keys and characters, although modification may be needed if the multi-touch screen is too small.

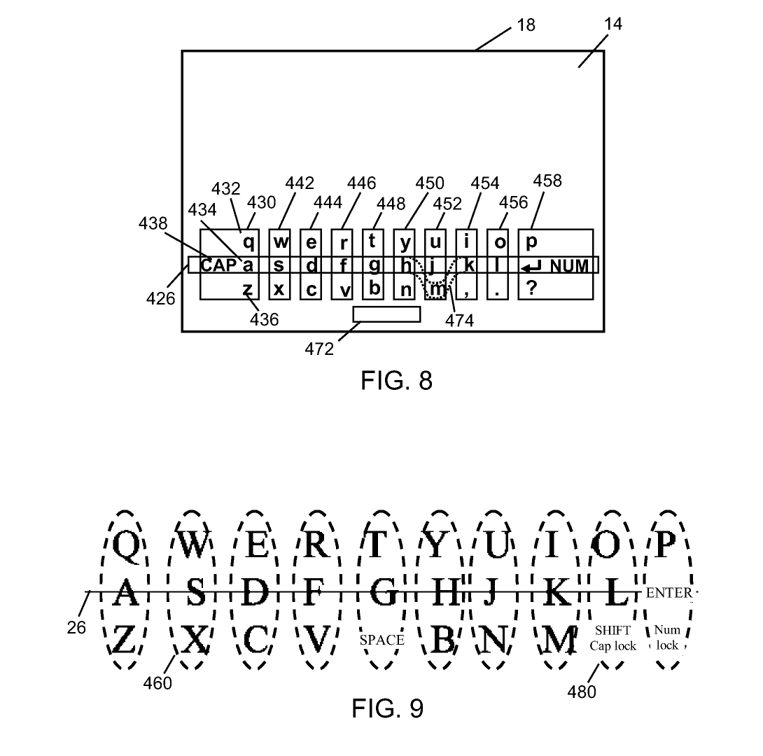

FIG. 8 shows an example of a layout of the home line keyboard for a smaller multi-touch screen, as may be found in a smart phone, for example. Ten key pads 430, 442, 444, 446, 448, 450, 452, 454, 456, 458 are shown with home line 426, corresponding largely to the keyboard layout of FIG. 2. A user may use one or more fingertips for inputting data using this embodiment. For example, a user may use two thumbs. By tapping a thumb on pad 430, the central key “a” 434 is registered. By swiping upwards within pad 430, character “q” 432 is registered. By swiping down within pad 430, character “z” 436 is registered. By swiping to the left within pad 430, Caps Lock 438 is activated. The other pads operate in a fashion similar to that already described. A common sub-pad 472 for use by either of the thumbs is included, and is here assigned to the Space character. Visual feedback can also be incorporated, such as the shifting of the home line 426 into position 474, for when the “m” character is registered, for example. The keyboard may alternately be configured to operate only via taps, rather than taps and sweeps.

FIG. 9 shows yet a further alternate keyboard layout, with home line 26 that can take on a curved form when implemented on a larger multi-touch screen, and ten key pads 460, each comprising three keys.

Different characters and different numbers of keys may be assigned to the pads and sub-pads in other embodiments.

Other character/key maps are possible. For example, when number lock is activated, the main pads may include numbers and the sub-pads, if present, may include the symbols found in the shift position on the number keys of a standard QWERTY keyboard. Also possible is an approximate mapping of the DVORAK keyboard, or according to national customs and different types of alphabet, such as needed for Greek, Russian and katakana.

Sub-pads below the main pads may be more difficult to use than ones placed above, but embodiments with one or more sub-pads below the main pads are still possible.

The locations of sub-pads as well as the pads are regularly monitored and adjusted, by constantly or periodically averaging the locations that are tapped or swiped.

When typing, a quick complete feature may be included, which automatically completes the word that is being typed or adds punctuation marks, according to a predictive and/or learning algorithm. For example, if “il” is typed, the algorithm will automatically register “I'll”, or if “dont” is typed, then “don't” will automatically be registered.

Fewer than ten key pads may be used in other embodiments. This may be useful if the multi-touch screen is too small to efficiently accommodate ten key pads in a home line, or if the user has one or more missing, amputated or injured fingers.

When operating any one of the keys on the home line keyboard 16, a character may be repeated by keeping the finger touching the key, in a similar way to conventional keyboards. Double taps may be used to register different characters. For example, a double tap on a Shift key 480 (FIG. 9) would switch on Caps Lock, whereas a single tap would simply shift only the subsequent key activated.

Two home lines may be used, one for each hand. The thickness of the home line may be different to that depicted herein. The thickness may vary, or be constant. The home line may be wide enough to encompass the key pads entirely, in which case the centre line of the home line would be the reference point for locating the central keys of the key pads. Side lines may be displayed above and below the home line, joining the upper and lower keys respectively.

It is expected that the benefit of optimizing the character assignments or key positions will be relatively small compared to the benefit of optimization of conventional keyboards. This is due to the more constant effort needed to activate each key in the adaptable home line keyboard, compared to the relatively large spread in movement and effort needed to activate different keys on a conventional keyboard. Depending on the configuration implemented, there may be no or minimal lateral movement of the hands required when using the adaptable home line keyboard.

To summarize industrial applicability, the advantages of the invention may include one or more of the following: minimal physical effort is necessary to register a character; less hand strain than for a conventional keyboard; reduced carpal tunnel syndrome; minimal learning burden if known keyboard layouts are mapped; less desk space needed compared to a conventional keyboard; no peripheral keyboard attachment is needed for devices such as notebooks, tablet computers or cell phones; it eliminates the need to have a dedicated keyboard area for notebooks; it may be easier for newcomers to learn because the keys are better aligned and positioned; key positions and keyboard layout can be customized easily to fit different individuals or an individual's different tasks; improved visualization of when a key is activated; and it is easy to implement into currently available electronic devices such as tablet computers.

As will be apparent to those skilled in the art in the light of the foregoing disclosure, many alterations and modifications are possible in the practice of this invention without departing from the scope thereof. Accordingly, the scope of the invention is to be construed in accordance with the substance defined by the following claims.

1. An electronic device with an adaptable keyboard, comprising:
a platform having a multi-touch surface configured with a keyboard;
a memory on the platform storing computer readable instructions; and
a processor on the platform connected to the memory and the multi-touch surface;
said computer readable instructions configured, upon processing by said processor, to cause the device to:
define a pad at each of a plurality of locations on the multi-touch surface, wherein:
each location corresponds to a different fingertip of a user;
each of the pads comprises three touch sensitive keys; and
each of the touch sensitive keys is assigned to a character;
detect activation of a selected one of the touch sensitive keys; and
register in the memory the character corresponding to the selected one of the touch sensitive keys activated;
wherein the keys of each of the pads include a central one of the keys located on a home line aligned with rest positions of the fingertips.

2. The device of claim 1, wherein the plurality is ten.

3. The device of claim 1, comprising a display behind the multi-touch surface, the display and multi-touch surface forming a multi-touch screen, wherein said computer readable instructions are further configured, upon processing by said processor, to cause the device to display the home line on the multi-touch screen.

4. The device of claim 3, further configured to display the home line temporarily altered when said selected key is activated.

5. The device of claim 3, further configured to display the home line temporarily deformed towards a non-central one of said keys not located on the home line when said non-central key is activated.

6. The device of claim 1, comprising a display behind the multi-touch surface, the display and multi-touch surface forming a multi-touch screen, wherein said computer readable instructions are further configured, upon processing by said processor, to cause the device to display the pads on the multi-touch screen.

7. The device of claim 1, wherein the pads are defined at said locations when the user's fingertips are simultaneously in contact with the multi-touch surface at said rest positions.

8. The device of claim 1, wherein, during activation of the keys, positions of contact of the user's fingertips with the multi-touch surface are monitored and used by the processor to update the locations at which the pads are defined.

9. The device of claim 1, wherein the device detects an activated key by detecting a tap on the activated key.

10. The device of claim 1, wherein the device detects an activated key by detecting a stroke on the multi-touch surface from the home line towards the activated key.

11. The device of claim 1, wherein the device detects an activated key by detecting a stroke on the multi-touch surface from the activated key towards the home line.

12. The device of claim 1, wherein the device detects an activated key by detecting a lifting and subsequent replacement of one of said fingertips from and to the activated key.

13. The device of claim 1, configured to operate as a keyboard when the rest positions of the fingertips are on the multi-touch surface.

14. The device of claim 1, configured to operate as a keyboard when the rest positions of the fingertips are apart from the multi-touch surface.

15. The device of claim 1, further configured to:
detect activation of two of the touch sensitive keys together; and
register in the memory a further character corresponding to said two keys being activated together.

16. The device of claim 1, further comprising one or more subsidiary pads located beyond said pads.

17. The device of claim 1, further configured to receive, from the user, an input assigning at least one of said keys to a character.

18. A method for operating an electronic device as an adaptable keyboard, comprising:
defining, by a processor in the device, a pad at each of a plurality of locations on a multi-touch surface of the device, wherein:
each location corresponds to a different fingertip of a user;
each of the pads comprises three touch sensitive keys; and
each of the touch sensitive keys is assigned to a character;
detecting, by the processor, activation of a selected one of the touch sensitive keys; and
registering, by the processor, in a memory of the device, the character corresponding to the selected one of the touch sensitive keys activated;
wherein the keys of each of the pads include a central one of the keys located on a home line aligned with rest positions of the fingertips.

19. The method of claim 18, further comprising:
displaying the home line on a screen of the device;
displaying the home line temporarily deformed towards a non-central one of said keys not located on the home line when said non-central key is activated.

20. An electronic device with a keyboard, comprising:
a platform having a multi-touch screen configured with a keyboard;
a memory on the platform storing computer readable instructions; and
a processor on the platform connected to the memory and the screen;
said computer readable instructions configured, upon processing by said processor, to cause the device to:
define a pad at each of a plurality of locations on the screen, wherein:
each of the pads comprises three touch sensitive keys; and
each of the touch sensitive keys is assigned to a character;
display a home line on the screen, wherein the keys of each of the pads include a central one of the keys located on the home line;
detect activation of a selected one of the touch sensitive keys;
register in the memory the character corresponding to the selected one of the touch sensitive keys activated; and
display the home line on the screen temporarily deformed towards a non-central one of said keys not located on the home line when said non-central key is activated.
